(19) United States
(12) Patent Application Publication
(10) Pub. No.: US 2026/0154835 A1
(43) Pub. Date: Jun. 4, 2026

(54) OBJECT 3D PROFILE IMAGE CAPTURE SYSTEM

(71) Applicant: Don LIN, Taipei City (TW)

(72) Inventor: Don LIN, Taipei City (TW)

(21) Appl. No.: 19/397,035

(22) Filed: Nov. 21, 2025

(30) Foreign Application Priority Data
Nov. 29, 2024 (TW) 113146423

(51) Int. Cl. G06T 7/571; G06T 3/14; H04N 23/69; H04N 23/695

(52) U.S. Cl. CPC G06T 7/571; G06T 3/14; H04N 23/69; H04N 23/695; G06T 2207/10028

(57) ABSTRACT

An object 3D profile image capture system determines a three-dimensional profile contour of an object under test by evaluating changes in focus quality across a plurality of slice images. The system includes a camera device, a moving device, and a control device. The camera device includes a lens module and an image sensor imaging module, wherein an object-side focal plane is formed by their relative positional relationship. The moving device is configured to move the camera relative to the object along a movement path, which is not perpendicular to the object-side focal plane. The control device is electrically connected to the camera and moving devices to control the movement and to acquire the plurality of slice images of the object as the camera moves along the path.

### BACKGROUND

### 1. Technical Field

The present disclosure relates to an object profile image capture system and method, and more particularly, to an object profile image capture system and method for analyzing a three-dimensional (3D) profile contour of an object from slice images acquired using a plurality of object-side focal planes that are tilted with respect to a movement path.

### 2. Description of the Related Art

For a schematic diagram of a prior art image capture system and a method for resolving a three-dimensional (3D) surface contour of an object using Depth From Focus (DFF), please refer to FIG. 1A, FIG. 1B, FIG. 2, and FIG. 3. The conventional DFF method for resolving the 3D surface contour of an object is to capture images in a scene with a camera device. From a series of multiple slice images obtained from the continuous movement of a focal plane across the object under test (a concept similar to computed tomography), the 3D depth information at all points of the object's profile is resolved by evaluating the change in focus quality of the object in each image. The typical architecture of the prior art, as shown in FIG. 1A, is configured such that the movement path 80a of the camera device 10a for acquiring image slices is perpendicular to the object-side focal planes 0, 1, 2, 3, and 4. In this case, the analysis procedure for the focus evaluation value of the object is relatively simple and clear because there is no horizontal image displacement between the slice images.

As shown in FIG. 1A, in the conventional image capture method, when the size of the object under test exceeds the measurable range of a single field of view (FOV) of the camera, the measurement has to be divided into multiple view areas to maintain the same resolution. The camera device 100a sequentially captures multiple slice images at fixed positions within each view area along the movement path 80a. During the period when the camera device 100a moves to the next view area, i.e., while moving along the movement path 81a, the camera device 100a remains idle and does not perform image acquisition. Consequently, the average frame rate of the entire image capture process is significantly lower than the maximum frame rate of the camera device 100a. This is similar to driving through alleys, where a vehicle must come to a full stop at every intersection before moving again, resulting in a much lower average driving speed than on the highway. For example, for a camera device 10a capable of capturing 180 images per second for a Field of View, if 90 image slices are required per FOV and the profiling area of a large object must be divided into, say, 100 FOV (e.g., 20×5 areas) for sector image capture, a total of 9,000 images (90 images×100 areas) and 100 planar displacement stop-and-go procedures are required. If switching to the next view area requires 0.5 to 1 second for acceleration, deceleration, and stabilization to a complete stop, then the entire process for 9,000 images requires at least 50 seconds of full-speed image capture time plus 50 to 100 seconds of movement time. An entire inspection cycle takes as long as 100 to 150 seconds. The camera's actual performance is only ½ to ⅓ of its maximum image capture efficiency (18,000 images @ 100 s˜27,000 images @ 150 s), resulting in low operational efficiency, thus indicating significant room for improvement.

The method for measuring an object's surface profile using conventional Depth From Focus (DFF) is detailed as follows. For ease of understanding, FIGS. 2 and 3 only depict five slice images 0a, 1a, 2a, 3a, 4a of the top surface apex 91f of the object under test 90f. Because the same camera device 10a has a fixed focal length, it can be seen from FIGS. 2 and 3 that the top surface apex 91f appears as a sharp image only in slice image 2a. In slice images 0a, 1a, 3a, and 4a, the top surface apex 91f) is a blurry image, ranging from slightly to severely out of focus. The Depth From Focus (DFF) method utilizes this transition of the object's image features from blurry to sharp and back to blurry to resolve the index number of the slice image where the object's profile is in sharp focus (i.e., the relative height of the top surface apex 91f). In this example sequence of five slice images, the slice image of the feature 91f with the index number 2a is the sharpest.

The evaluation of object sharpness in a scene image is most commonly performed using a Laplacian filter to evaluate the gradient of grayscale value difference between adjacent pixels of a feature point in the object's image. It is a gradient function convolution operation that calculates the grayscale gradient change at each image pixel location; that is, a convolution operation is performed between the grayscale value of each pixel and the grayscale values of its surrounding adjacent pixels.

$$g ( x , y ) = ω * f ( x , y ) = {\sum }_{i = - a}^{a} {\sum }_{j = - b}^{b} ω ( i , j ) f ( x - i , y - j )$$

The kernel is as shown in FIG. 1B. FIG. 1B shows a table for example parameters for a 3×3 gradient function convolution operator (convolution range values a and b are both 1). If there are noise concerns in the slice images acquired by the camera device 100a, a smoothing filter (such as a Gaussian filter) can be applied first, followed by the Laplacian operation. The smoothing filter and the Laplacian filter can be combined into a single filter (LoG, i.e., Laplacian of Gaussian) to save computational power; details of the Gaussian filter are omitted here for brevity.

As shown in FIG. 1B, the convolution operation values for the same pixel at each slice are collected to form a one-dimensional array of image sharpness evaluation strength values. This one-dimensional array is searched to find and record the slice index number where the maximum evaluation value is located. To obtain more precise depth resolution, a trend interpolation can be performed on the focus evaluation values of the preceding and succeeding slice images to achieve a higher-precision floating-point index value. In practical applications of conventional DFF detection, most involve imaging with an equivalent long focal length and a narrow-angle field of view. When capturing images at a fixed focal plane by relatively moving the camera or the object under test, a slight magnification variation exists between the out-of-focus image on a non-focal plane and the in-focus image on the focal plane. However, this variation does not significantly affect the resolution of the one-dimensional array's focus layer index for each pixel region (e.g., 3×3, 5×5). Using a telecentric lens (a virtual ultra-long focal length design) can be more precise, but the lens cost is relatively much higher.

A matrix of the recorded slice index values for all pixels constitutes the relative depth values of the three-dimensional (3D) surface profile of the object under test in the image coordinate system. Furthermore, the distance value between adjacent slice planes of the object-side focal plane where the camera device 100a moves to capture images (the spacing between two adjacent planes among focal planes 0, 1, 2, 3, 4) serves as the unit conversion constant from the image pixel coordinate system to a real-world coordinate system. From this, the final real-world 3D depth map of the object under test can be obtained.

A Depth From Focus (DFF) measurement system can capture images by moving the camera device 100a along the Z-axis on a transfer platform (not shown) that carries the camera device 100a, or by moving the platform of the object under test along the Z-axis. It is to be noted here that the Z-axis direction refers to the vertical direction. Both methods of relative movement can be used to acquire a series of slice images in which the focus falls on different positions (relative depths) before and after the object.

Although there have recently been optical lenses with built-in variable-surface liquid lenses or alternative designs using DLP (DMD) reflective mirror optical paths to electronically simulate a focus ring function, thereby eliminating the procedure of moving the camera device 100a or the object under test 90f, these methods have drawbacks. While images obtained with liquid lenses or DLP (DMD) reflective mirrors have the advantage of low vibration, the inherently non-linear hyperbolic relationship (1/p+1/q=1/f) between the lens's object distance (p) and image distance (q) causes large variations in the control precision of the imaging distance. Furthermore, the process of capturing slice images with continuously changing magnification requires magnification correction (in contrast to the method described in paragraph [0007]), which increases the complexity of subsequent image processing procedures. Moreover, the device must still remain at a fixed point (horizontally stationary) and capture multiple slice images along the vertical direction (Z-axis). It is therefore completely unable to escape the fate of low operational efficiency described in paragraph [0003].

### SUMMARY

The objective of the present disclosure is to provide an object profile image capture system for analyzing a three-dimensional (3D) profile contour of an object from slice images acquired using a plurality of object-side focal planes that are tilted (not parallel) with respect to a movement path of a camera device.

Another objective of the present disclosure is to provide an object profile image capture method for analyzing a 3D profile contour of an object from slice images acquired using a plurality of object-side focal planes that are tilted (not parallel) with respect to a movement path of a camera device.

To achieve the aforementioned objectives, the object profile image capture system and method of the present disclosure analyzes the 3D profile contour of an object under test by evaluating changes in focus quality of slice images acquired from a plurality of object-side focal planes tilted with respect to the movement path of the camera device. The system includes a camera device, a moving device, and a control device. The camera device includes a lens module and an image sensor imaging module, and an object-side focal plane is formed by the relative positional relationship between the lens module and the image sensor imaging module. The moving device is for moving the camera device relative to the object under test along a movement path, wherein the movement path is not perpendicular to the object-side focal plane. The control device is electrically connected to the camera device and the moving device to control the movement of the moving device, and it controls the camera device to acquire a plurality of slice images of the object under test as the camera device moves relative to the object along the movement path.

The present disclosure utilizes the feature that the movement path of the camera device is not perpendicular to the object-side focal plane. Accordingly, the camera device of the present disclosure only needs to perform “continuous” image capture while moving laterally (e.g., along the X-axis of the transfer platform carrying the camera device, or via a coordinated and interpolated path on the XZ plane of the platform), such that the image capture rate of the camera device can approach the maximum possible inspection capture rate. Taking as an example the case mentioned in paragraph [0003] of the prior art, the present disclosure requires only approximately 51 to 52 seconds for image capture (including acceleration/deceleration buffer at the beginning and end) and 2.5 to 5 seconds of idle time for row-switching movement (e.g., along the Y-axis). The total time is less than 57 seconds, which is merely about 40% to less than 50% of the inspection cycle time required by the conventional method. This is equivalent to the present disclosure enhancing the inline inspection capability of a production line by more than 2× to 2.5× and improving the operational availability of the camera's image capture. As a result, the drawback of the prior art—where the camera device remains idle and does not perform image capture while moving between multiple view areas, leading to low image capture availability and low inspection capability—is resolved.

### BRIEF DESCRIPTION OF THE DRAWINGS

FIG. 1A is a schematic diagram of a prior art image capture system.

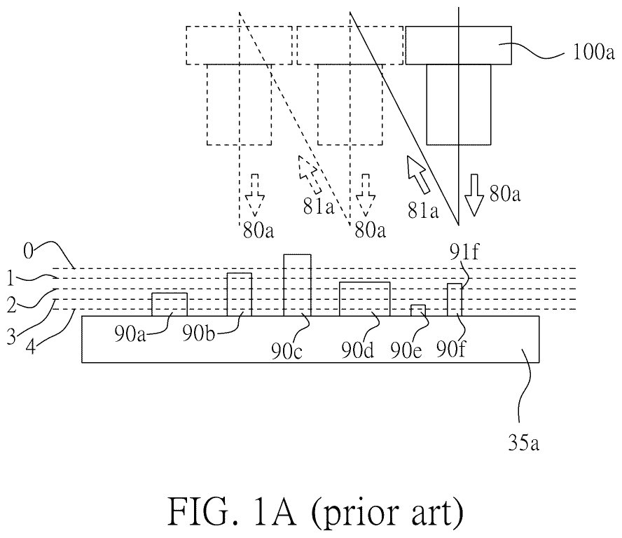

FIG. 1B shows a table for example parameters for a 3×3 gradient function convolution operator (convolution range values a and b are both 1).

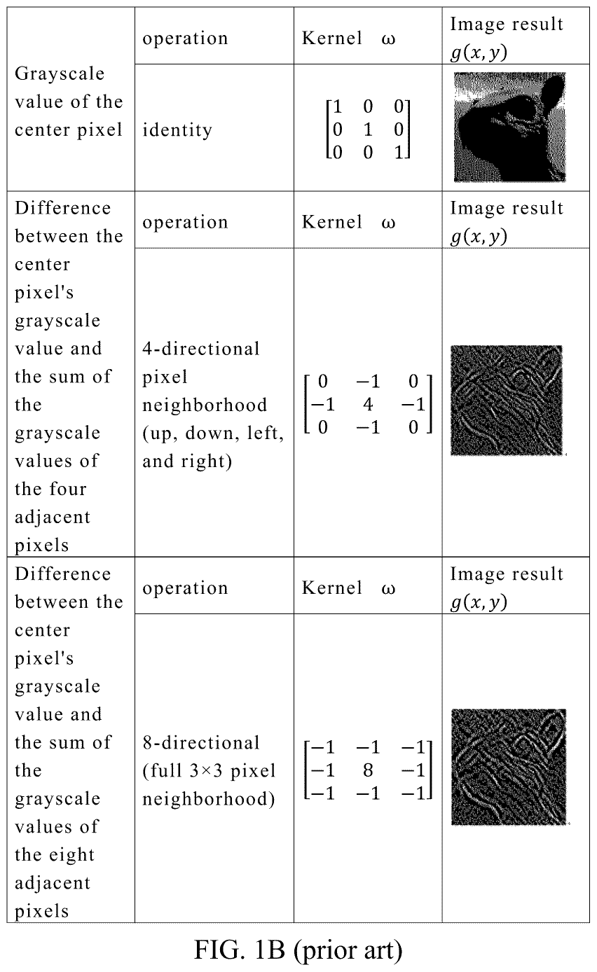

FIG. 2 is a schematic diagram of acquiring slice images using the prior art image capture system.

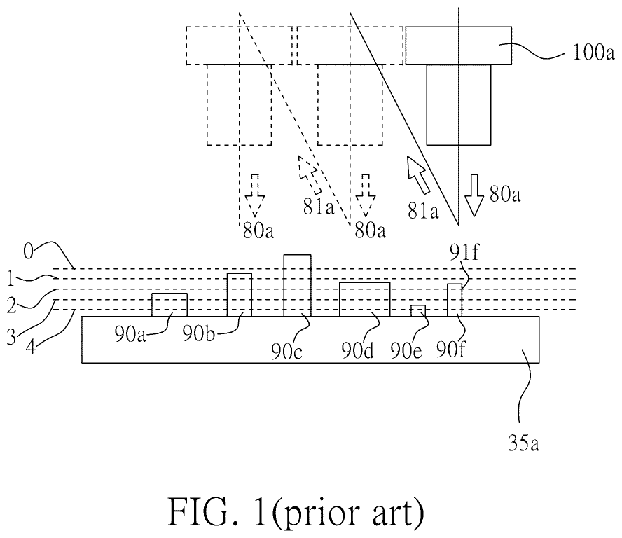

FIG. 3 is a schematic diagram illustrating the selection of a slice image index number in a prior art focus analysis.

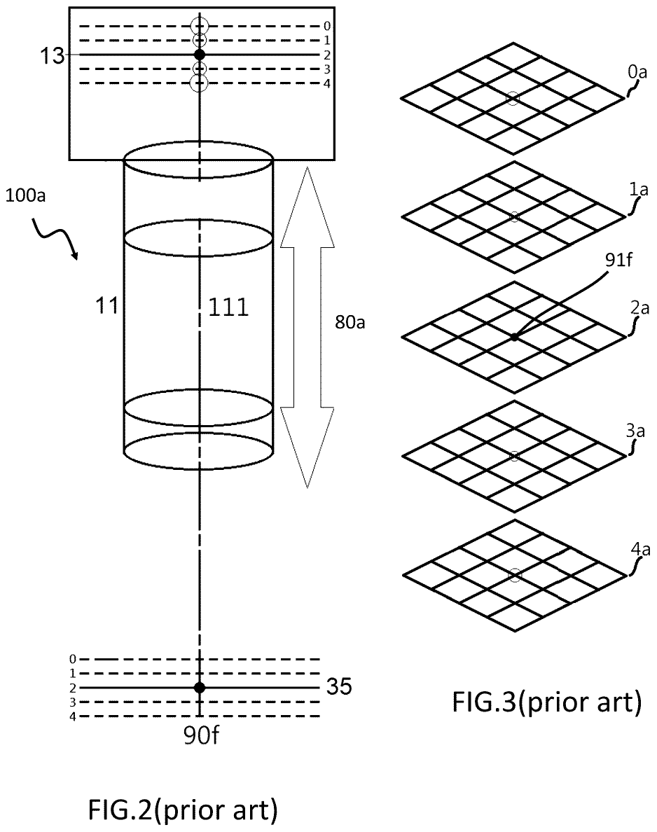

FIG. 4A is a top view of the object profile image capture system of the present disclosure.

FIG. 4B is a block diagram of the image processing module of the object profile image capture system of the present disclosure.

FIG. 5A is a schematic side view illustrating image capture by the object profile image capture system of the present disclosure, using a third embodiment of a lens module moving along a first embodiment of a movement path.

FIG. 5B is a schematic diagram illustrating the pixel offset alignment process for the slice images of the present disclosure.

FIG. 6 is a schematic diagram of a first embodiment of a lens module suitable for the object profile image capture system of the present disclosure.

FIG. 7 is an illustration of the application of the Scheimpflug principle to the first embodiment of the lens module of the present disclosure.

FIG. 8 is a schematic diagram of a second embodiment of a lens module suitable for the object profile image capture system of the present disclosure.

FIG. 9 is a schematic diagram of a third embodiment of a lens module suitable for the object profile image capture system of the present disclosure.

FIG. 10 is a schematic side view illustrating image capture by the object profile image capture system of the present disclosure, using a second embodiment of a lens module moving along a second embodiment of a movement path.

FIG. 11 is a flowchart of a first embodiment of the object profile image capture method of the present disclosure.

FIG. 12 is a schematic diagram illustrating the pixel offset alignment process for slice images acquired using the second embodiment of the lens module of the present disclosure.

FIGS. 13A and 13B are schematic diagrams of the images to be evaluated, which are generated after the pixel offset alignment process on the slice images is completed.

FIGS. 14A and 14B are schematic diagrams illustrating the transformation of a 3D depth map from an image coordinate system (based on the object-side focal plane normal) to a world coordinate system (based on the first plane normal) for slice images acquired using the second embodiment of the lens module of the present disclosure.

FIG. 15 is a flowchart of a second embodiment of the object profile image capture method of the present disclosure.

FIG. 16 is a schematic diagram of trapezoidal distortion correction for an image on an image sensor corresponding to the focal plane.

FIG. 17 is a flowchart of a third embodiment of the object profile image capture method of the present disclosure.

FIG. 18 is a schematic diagram illustrating the imaging focus of an object point on the focal plane as captured by an image sensor, showing the transition from blurry to sharp and back to blurry, when using the third embodiment of the lens module of the present disclosure.

FIG. 19 is a schematic diagram illustrating the pixel offset alignment process for slice images acquired using the third embodiment of the lens module of the present disclosure.

FIGS. 20 to 22 are schematic diagrams illustrating the final transformation of slice images into a world coordinate system image after being processed by the object profile image capture method of the present disclosure, when using the third embodiment of the lens module.

### DETAILED DESCRIPTION OF THE EMBODIMENTS

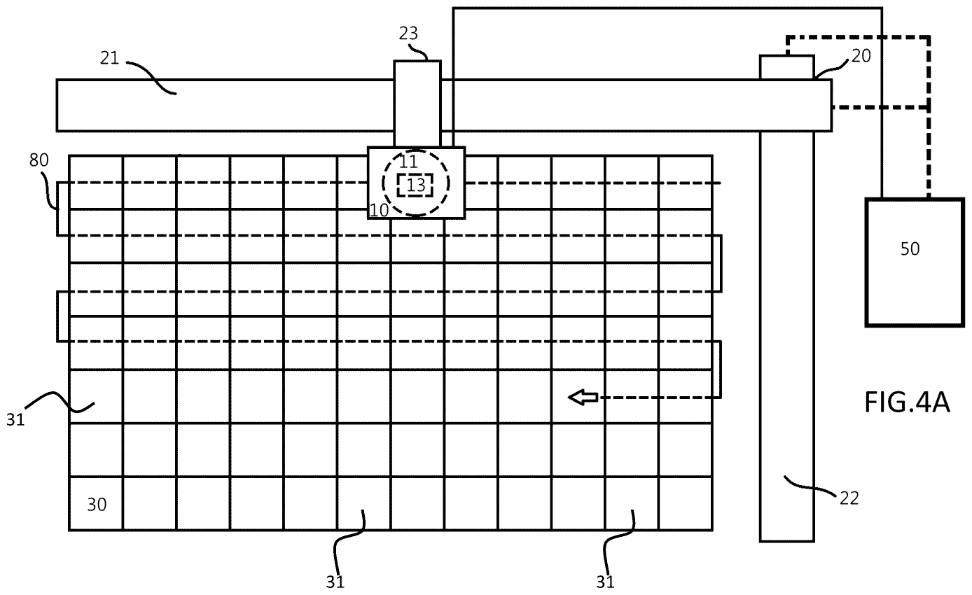

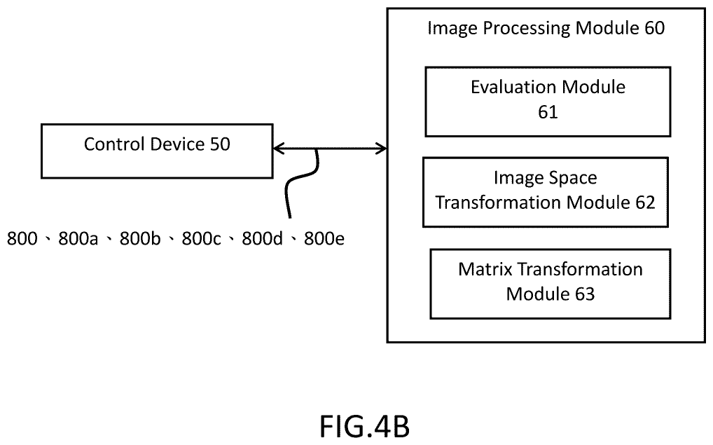

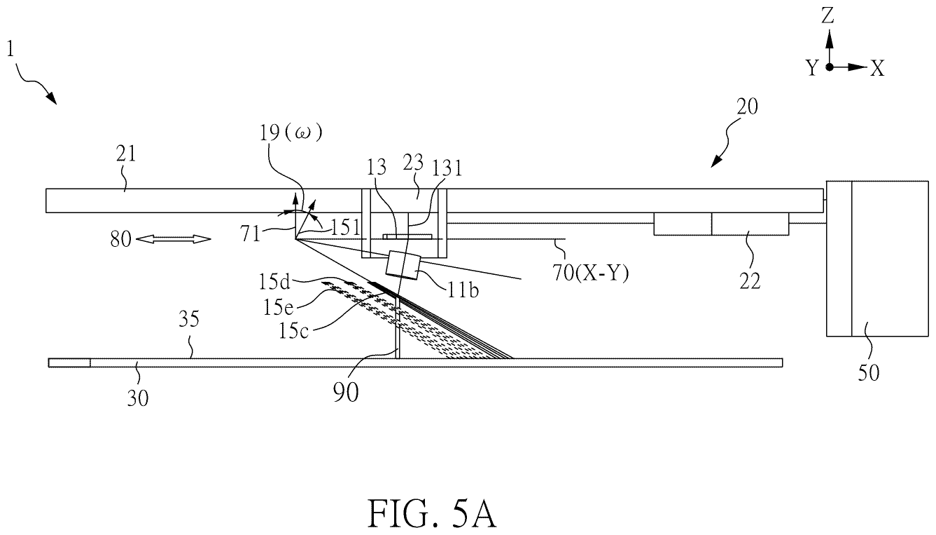

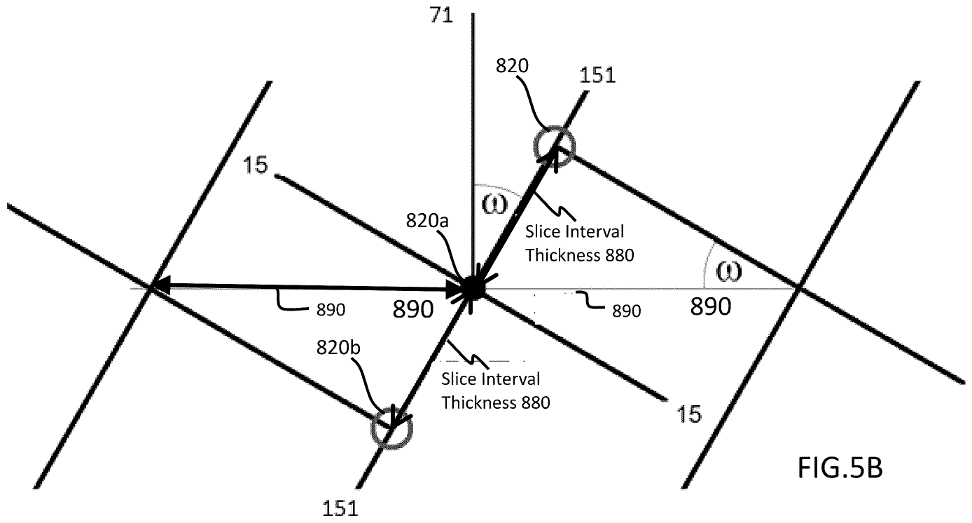

To provide a better understanding of the technical content of the present disclosure, preferred embodiments are described below. Please refer now to FIGS. 4A, 5A, and 5B, which are, respectively, a top view of the object profile image capture system of the present disclosure; a schematic side view illustrating image capture by the object profile image capture system of the present disclosure using a third embodiment of a lens module moving along a first embodiment of a movement path; and a schematic diagram of the pixel offset alignment process for the slice images.

As shown in FIGS. 4A and 5A, in a first embodiment of the present disclosure, the object profile image capture system 1 of the present disclosure is used to find a profile contour 91 of an object under test 90 by evaluating the change in focus quality of slice images acquired from a plurality of object-side focal planes tilted with respect to the moving direction of the camera device. The object under test 90 can be, for example, a circuit board, a motherboard, or surface-mount technology (SMT) components such as IC chips, resistors, capacitors, inductors, bare die, and wafers. In this embodiment, the object profile image capture system 1 of the present disclosure includes a camera device 10, a moving device 20, an object platform 30, and a control device 50. The camera device 10 includes a lens module 11 and an image sensor imaging module 13. The relative positional relationship between the lens module 11 and the image sensor imaging module 13 defines an object-side focal plane 15. Essentially, the object-side focal plane 15 can be considered the clear image capture slice plane of the camera device 10. According to one specific embodiment of the present disclosure, the relative positional relationship between the lens module 11 and the image sensor imaging module 13 is determined according to the Scheimpflug Intersection Principle to define the corresponding object-side focal plane 15; however, the present disclosure is not limited to this embodiment.

The moving device 20 moves the camera device 10 relative to the object under test 90 along a movement path 80, wherein the movement path 80 of the moving device 20 is not perpendicular to the object-side focal plane 15. The control device 50 is electrically connected to the camera device 10 and the moving device 20. The control device 50 controls the movement of the moving device 20, and as the camera device 10 moves relative to the object under test 90 along the movement path 80, it controls the camera device 10 to respectively acquire slice images of the object under test 90 at the object-side focal planes 15c, 15d, and 15e, thereby forming the plurality of slice images referred to in the present disclosure. It should be noted that, as shown in FIG. 5A, the camera device 10 of this embodiment moves relative to the object under test 90 along the movement path 80 on a first plane 70. In this embodiment, the first plane 70 is parallel to an object platform reference plane 35 formed by the object platform 30, which is the XY plane in FIG. 5A. It should also be noted that, as shown in FIGS. 5A and 5B, the object-side focal plane 15 has a focal plane normal 151. The linear distance between adjacent object-side focal planes 15c, 15d, and 15e (along the direction of the focal plane normal 151) is defined as the slice interval thickness 880. The moving distance of the camera device 10 on the first plane 70 along the direction of the path 80 from one object-side focal plane (e.g., from 15d to 15e) to the next is defined as the image capture interval distance 890.

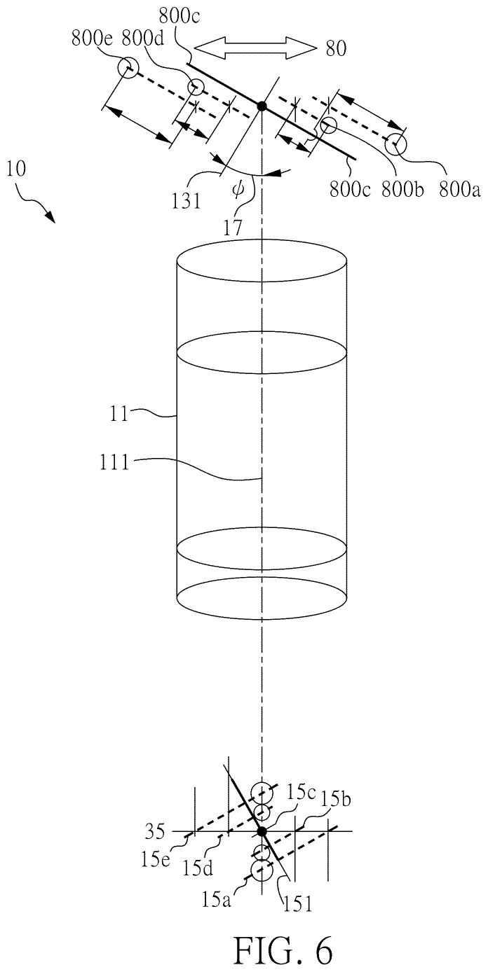

According to a specific embodiment of the present disclosure, the image capture frequency of the camera device 10 is from 1 to 1000 frames per second. The lens module 11 can be a lens composed of a single optical lens or multiple optical lenses, such as a microscope lens, a large numerical aperture (NA) lens with a shallow depth of field, or a telecentric lens with an ultra-long equivalent focal length (EFL). The image sensor imaging module 13 can be a charge-coupled device (CCD), a complementary metal-oxide-semiconductor (CMOS) device, or an indium gallium arsenide (InGaAs) device. The object-side focal plane 15 is determined according to the Scheimpflug principle by the relative angle between the lens module 11 and the image sensor imaging module 13 as used in the camera device 10, which is the sensor tilt angle 17 (φ) shown in FIG. 6.

As shown in FIGS. 4A and 5A, the object under test 90 is positioned on the object platform 30, and the object platform 30 defines an object platform reference plane 35. The object platform 30 can be divided into multiple camera fields of view (FOV) 31 to facilitate the acquisition of slice images of the object under test 90 by the camera device 10. In this embodiment, the moving device 20 includes a first-axis guide rail 21, a second-axis guide rail 22, a third-axis guide rail 23, and actuators (not shown) provided on each transfer axis, thereby allowing the height measurement range of the camera device 10 to be adjusted according to different application requirements. The first-axis guide rail 21 serves as an X-axis guide rail, the second-axis guide rail 22 as a Y-axis guide rail, and the third-axis guide rail 23 as a Z-axis guide rail. The third-axis guide rail 23 is configured to move along the first-axis guide rail 21 and the second-axis guide rail 22, thereby enabling the camera device 10 to perform various coordinated combinations of oblique linear movements in space or on planes (XZ, XY, YZ, XYZ), and to move upward, downward, leftward, rightward, forward, and backward above the object platform 30. In this embodiment, the camera device 10 is mounted on the third-axis guide rail 23. By means of the first-axis guide rail 21, the second-axis guide rail 22, and the third-axis guide rail 23, the camera device 10 is configured to cover the entire imaging area of the object platform 35 as shown in FIG. 4A. In this embodiment, the control device 50 can be implemented as a controller, processor, or control software installed in an electronic device such as a computer or a programmable logic controller (PLC).

It should be noted that the first plane 70 has a first plane normal 71. When the first plane 70 corresponds to the XY plane, the first plane normal 71 corresponds to the Z-axis. In such a case, when the camera device 10 performs image capture along the movement path 80 on the XY plane, the third-axis guide rail 23 (Z-axis) does not need to move vertically relative to the first-axis guide rail 21 (X-axis). That is, the third-axis guide rail 23 carrying the camera device 10 only needs to move laterally along the first-axis guide rail 21 (i.e., leftward or rightward, as shown in FIGS. 4A and 5A) to complete sequential image capture. As illustrated in FIGS. 4A, 5A, and 5B, during the movement of the camera device 10 along the movement path 80, the camera device 10 is positioned at different locations that are separated by an image capture interval distance 890. Accordingly, while the camera device 10 continuously moves and acquires images, it respectively acquires slice images corresponding to the object-side focal planes 15c, 15d, and 15e at each image capture position. These slice images exhibit a progression of the image of the object under test 90 from blurry to sharp and then back to blurry, and are subsequently used to analyze the 3D profile contour of the object under test 90.

Furthermore, according to a specific embodiment of the present disclosure, and as shown in FIG. 5A, the focal plane normal 151 of the object-side focal plane 15 forms a focal plane tilt angle 19(ω) with respect to the first plane normal 71. The focal plane tilt angle 19(ω) may fall within a range of 0.1 to 60 degrees, 1 to 10 degrees, 0.5 to 20 degrees, or 0.1 to 45 degrees. As illustrated in FIG. 5A, because the object-side focal plane 15 of the present disclosure is not parallel to the first plane 70, the slice images acquired by the camera device 10 during continuous image capture along the movement path 80 on the first plane 70 are in fact oblique slice images. These oblique slice images are capable of revealing more detailed profile features on the side surfaces of the object under test 90. An additional advantage of the focal plane tilt angle 19(ω) in the present disclosure is that it can be adjusted according to the required depth measurement range of the object under test 90. For example, when the object under test 90 is a circuit board, a motherboard, or a surface-mount component having a relatively large component height, the focal plane tilt angle 19(ω) can be increased (e.g., to 25°, 45°, or) 60° to obtain a clearer and more detailed contour of the side surface of the object under test 90. Conversely, when the object under test 90 is a low-profile component, such as an IC chip, resistor, capacitor, inductor, bare die, or wafer, the focal plane tilt angle 19(ω) can be decreased (e.g., to 1°, 5°, or 10°) to obtain depth measurement information from within high-aspect-ratio holes of the object under test 90.

According to a specific example, a SONY CMOS IMX535 image sensor imaging module 13 with specifications of 4K×3K resolution, an 11.2 mm×8.2 mm (H×V) sensor size, 12 million pixels, and a 2.74 μm pixel size is employed. When the object profile image capture system 1 of the present disclosure is applied to an optical inspection system for a surface-mount technology (SMT/SMD) production line, where the measurement height range of the objects is relatively large, trigonometric calculation indicates that, if the focal plane tilt angle 19(ω) is set to 30 degrees and used in conjunction with an optical magnification of 0.5× of the camera device 10, a height measurement range of approximately 11.2 mm can be obtained (Sin 30°/0.5×=1). Conversely, when the object profile image capture system 1 is applied to a wafer surface optical inspection system, where the measurement height range is relatively narrow, a height measurement range of approximately 100 μm can be obtained when the focal plane tilt angle 19(ω) is set to 2.56 degrees and used with an optical magnification of 5× (e.g., a microscope objective lens) in the camera device 10. Accordingly, the system provides a flexibly adjustable measurement height range over a span of approximately 1120 times.

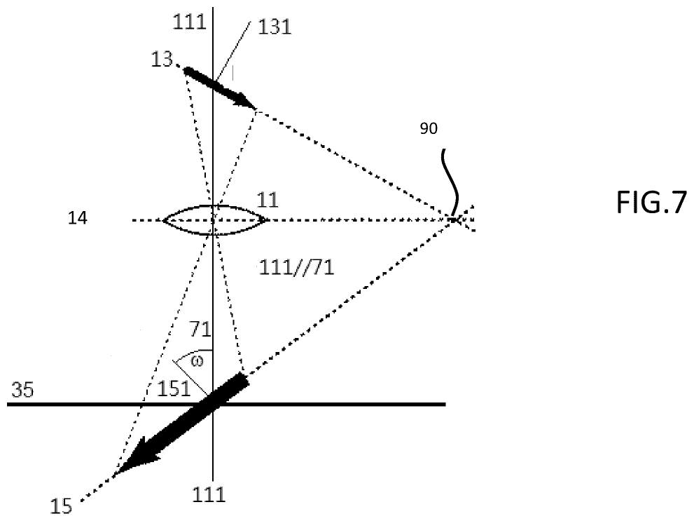

Please continue to refer to FIGS. 4A and 5A, and also to FIGS. 6 and 7, which illustrate a first embodiment of a lens module suitable for use in the present disclosure and the application of the Scheimpflug principle in this embodiment.

As shown in FIG. 6, in the first embodiment of the lens module 11, the movement path 80 refers to the path along which the camera device 10 moves horizontally on the first plane 70, which is the XY plane formed by the first-axis guide rail 21 (the X-axis) and the second-axis guide rail 22 (the Y-axis). In this embodiment, an optical axis 111 of the lens module 11 is perpendicular to the movement path 80. A normal to the image sensor imaging plane 131 of the image sensor imaging module 13 forms a sensor tilt angle 17(φ) with the optical axis 111 of the lens module 11, and the sensor tilt angle 17(φ) has an angular range of 0.1 to 60 degrees. When the camera device 10 moves along the movement path 80 on the first plane 70, the respective object-side focal planes 15a, 15b, 15c, 15d, and 15e are imaged on the image sensor imaging module 13 as the slice images 800a, 800b, 800c, 800d, and 800e shown in FIG. 6. The tilt angle of the focal plane is determined in accordance with the corresponding relationship of the Scheimpflug principle as illustrated in FIG. 7. It should be noted that the sensor tilt angle 17(φ) of the present disclosure can be adjusted in accordance with practical applications based on the shape and size of the object under test 90. For example, when the object under test 90 is a circuit board, a motherboard, or a surface-mount component having a large measurement height range, the sensor tilt angle 17(φ) can be increased, for instance to 25°, 45°, or 60°. When the object under test 90 is a component having a small measurement height range, such as an IC chip, a resistor, a capacitor, an inductor, a bare die, or a wafer, the sensor tilt angle 17(φ) can be decreased to 1°, 5°, or 10°, which is suitable for measuring a three-dimensional profile and the bottom depth of holes at a micron-level high resolution.

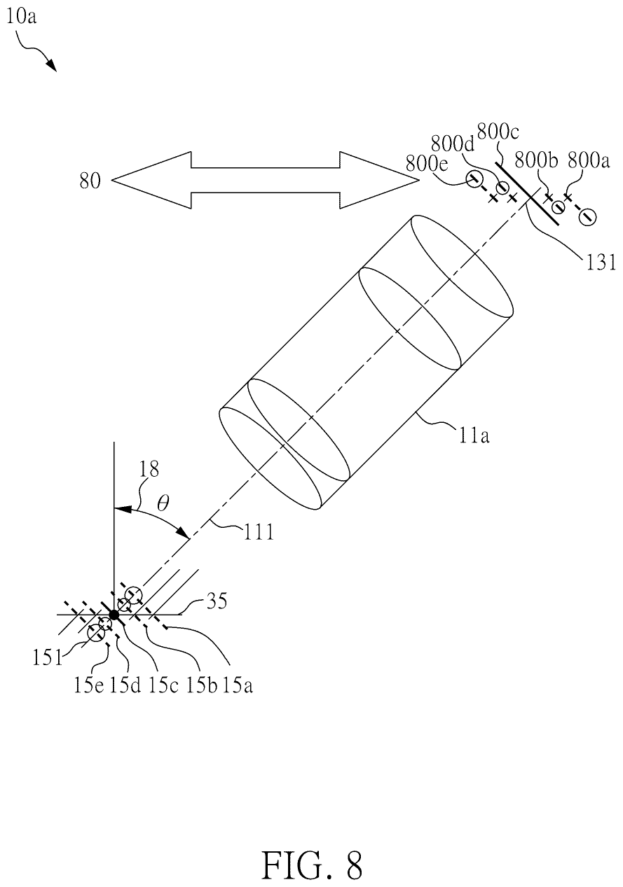

Please continue to refer to FIGS. 4A and 5A, and also to FIG. 8, which illustrates a second embodiment of a lens module suitable for use in the present disclosure.

As shown in FIG. 8, in the second embodiment of the lens module 11a, the movement path 80 refers to the path along which the camera device 10 moves horizontally on the first plane 70, which is the XY plane. In the lens module 11a of this embodiment, an optical axis 111 of the lens is not perpendicular to the movement path 80, and the image sensor imaging module 13 is arranged such that the normal to the image sensor imaging plane 131 is parallel to the optical axis 111 of the lens. Furthermore, in this embodiment, a lens tilt angle 18(θ) is defined as the angle formed between the optical axis 111 of the lens and the movement path 80, and the lens tilt angle 18(θ) has an angular range of 0.1 to 60 degrees. It should be noted that the camera lens module 11a used in this embodiment is a commonly used conventional optical lens module. Because the optical axis 111 of the lens is not perpendicular to the movement path 80, when the lens module 11a moves along the movement path 80 on the first plane 70, the respective object-side focal planes 15a, 15b, 15c, 15d, and 15e are imaged on the image sensor imaging module 13 as the slice images 800a, 800b, 800c, 800d, and 800e shown in FIG. 8. The lens tilt angle 18(θ) can be adjusted according to the shape and size of the object under test 90. Specifically, when the object under test 90 is a circuit board, a motherboard, or a surface-mount component having a large height, the lens tilt angle 18(θ) can be increased, for instance to 25°, 45°, or 60°, to obtain side profile measurements of the object under test 90, which is not achievable by the conventional DFF method in which the lens centerline moves vertically along the Z-axis for image capture. When the object under test 90 is a component having a small height, such as an IC chip, a resistor, a capacitor, an inductor, a bare die, or a wafer, the lens tilt angle 18(θ) can be decreased, for instance to 1°, 5°, or 10°, so that the external side surfaces or the inner walls of holes having an aspect ratio of 57.3:1 or greater can be measured at a high depth resolution.

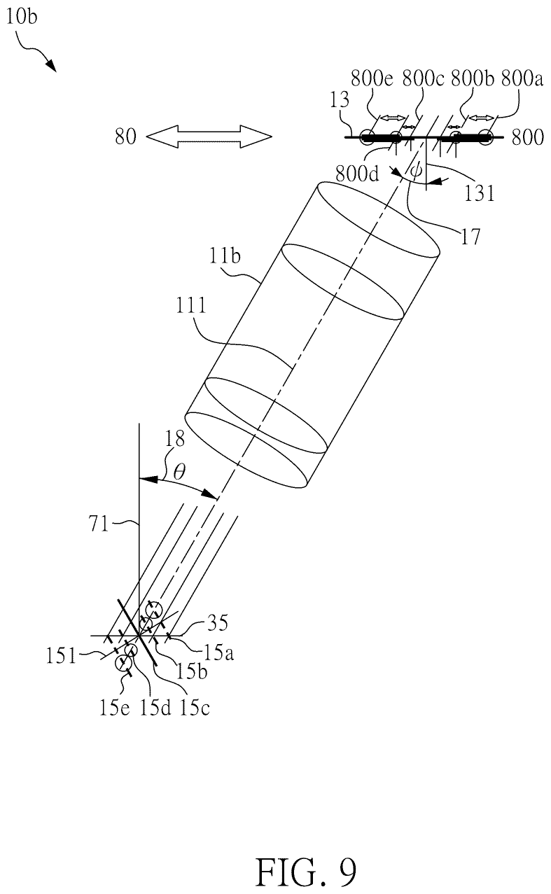

Please continue to refer to FIGS. 4A and 5A, and also to FIG. 9, which illustrates a third embodiment of a lens module suitable for use in the present disclosure.

As shown in FIG. 9, in the third embodiment of the lens module 11, the movement path 80 refers to the path along which the camera device 10 moves horizontally on the first plane 70, which is the XY plane. In the lens module 11b of this embodiment, the optical axis 111 of the lens is not perpendicular to the movement path 80, and the image sensor imaging plane 13 is parallel to the movement path 80. This means that the sensor tilt angle 17(φ) is equal to the lens tilt angle 18(θ), and the angular ranges of φ and θ are both from 0.1 to 60 degrees. When the camera module 10b moves along the movement path 80 on the first plane 70, the respective object-side focal planes 15a, 15b, 15c, 15d, and 15e are imaged on the image sensor imaging module 13 as the slice images 800a, 800b, 800c, 800d, and 800e shown in FIG. 9. The sensor tilt angle 17(φ) and the lens tilt angle 18(θ) in this embodiment can be adjusted according to the type of the object under test 90. For example, when the object under test 90 is a circuit board, a motherboard, or a surface-mount component with a large height, the angles φ and θ can be increased, for instance to 25°, 45°, or 60°, so that a clearer and more detailed side contour of the object under test 90 can be obtained. When the object under test 90 is a component with a small height, such as an IC chip, a resistor, a capacitor, an inductor, a bare die, or a wafer, the angles φ and θ can be decreased, for instance to 1°, 5°, or 10°, so that a measurable aspect ratio of 57:1 or greater can be achieved, similar to the lens module 11a of the second embodiment.

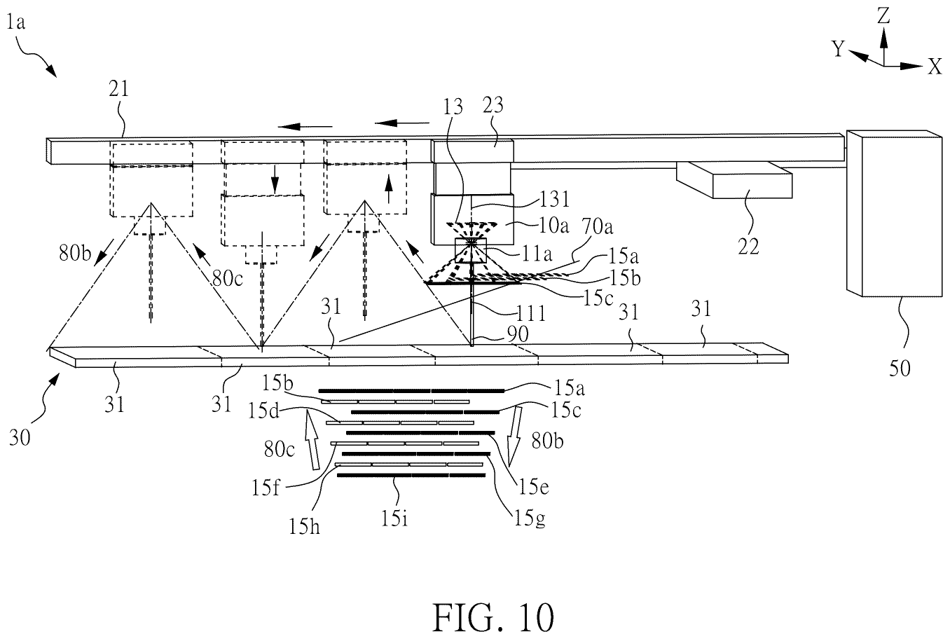

Please continue to refer to FIGS. 4A and 5A, and also to FIG. 10, which illustrates a side view of image capture by the object profile image capture system of the present disclosure, using the second embodiment of the lens module moving along a second embodiment of a movement path.

As shown in FIGS. 4A, 5A, and 10, the difference between the second embodiment movement paths 80b and 80c and the first embodiment movement path 80 is that, when the camera device 10 captures images along the movement paths 80b and 80c of the second embodiment, the third-axis guide rail 23 (Z-axis) moves vertically relative to the first-axis guide rail 21 (X-axis) while simultaneously moving horizontally in the ±X direction. This coordinated motion causes the third-axis guide rail 23 carrying the camera device 10 to move obliquely (i.e., diagonally upward or diagonally downward) relative to the first-axis guide rail 21. Thus, in this embodiment, the movement path comprises an upward oblique path (movement path 80c) and a downward oblique path (movement path 80b). At this time, the first plane 70a is an oblique movement plane (XZ plane) defined by the first-axis guide rail 21 and the third-axis guide rail 23. Specifically, as can be seen from the side view of FIG. 10, the image sensor imaging plane normal 131 of the camera device 10a is parallel to the optical axis 111 of the lens, and both are perpendicular to the object platform reference plane 35. From the viewing perspective of FIG. 10, the overall motion of the camera device 10a consists of a repeatedly reversing oblique scanning path (80b and 80c) on the XZ plane, forming a path similar to a V-shaped pattern (V, VV, VVV, and so on). The oblique linear scanning paths (+X−Z and +X+Z) are formed by the coordinated movement of the first-axis guide rail 21 and the third-axis guide rail 23. It should be noted that the object-side focal planes 15a, 15b, 15c, 15d, 15e, 15f, 15g, 15h, and 15i corresponding to the movement paths 80b and 80c are parallel to the object platform reference plane 35. At this time, the object profile image capture system 1 employs the camera device 10a shown in FIG. 8, namely the lens module 11a, in which the image sensor imaging plane normal 131 is parallel to the optical axis 111 of the lens. The lens module 11a is a commonly used conventional optical lens module.

As shown in FIG. 10, in this embodiment, because the object-side focal plane 15 is parallel to the object platform reference plane 35 (which is the same as the focal plane used in the prior-art DFF image capture), the following occurs in the embodiment of the movement paths 80b and 80c, which are oblique linear paths (+X−Z and +X+Z) formed by the coordinated motion of the first-axis guide rail 21 and the third-axis guide rail 23, as illustrated in FIG. 10. When the camera device 10a moves along the movement path 80b toward the object under test 90, the camera device 10a sequentially acquires slice images of the object-side focal planes 15a, 15c, 15e, 15g, and 15i. When the camera device 10a then moves along the movement path 80c away from the object under test 90, it sequentially acquires slice images of the object-side focal planes 15h, 15f, 15d, and 15b. In other words, according to a specific embodiment of the present disclosure, when the movement paths 80b and 80c on the first plane 70a are not parallel to the first-axis guide rail 21, although the individual slice interval thickness 880 during image capture along each of the movement paths 80b and 80c remains 880, the slice images acquired along the V-shaped bidirectional image capture paths 80b and 80c are interlaced and combined. As a result, the effective overall slice interval thickness of the image capture performed by the camera device 10a along the movement paths 80b and 80c becomes one half of the slice interval thickness 880. That is, the overall slice resolution is effectively doubled.

For example, as shown in FIG. 10, when the camera device 10a moves and captures images along the movement paths 80b and 80c on the first plane 70a, the camera device 10a performs interval image capture along the movement paths 80b and 80c, for instance, capturing slice images with index numbers 1, 3, and 5 on movement path 80b, and then capturing index numbers 2, 4, and 6 on movement path 80c. The originally captured sequence is then reordered and interlaced for stacking, such that the slice images are stacked in the order of index numbers 1, 2, 3, 4, 5, and 6. The depth range covered by the camera device 10a along the movement paths 80b and 80c in this embodiment, similar to the prior art, depends on the working distance specification of the front end of the lens. At the same time, in this embodiment, the movement paths 80b and 80c are determined by the hypotenuse of a right triangle formed by half of the horizontal field of view of the camera device 10a and the depth of the Z-axis slice movement.

Furthermore, when the camera device 10a transitions from the movement path 80b (upward path) to the movement path 80c (downward path), or from the movement path 80c (downward path) to the movement path 80b (upward path), the camera device 10a needs to be positionally shifted upward or downward by half of the slice interval thickness 880 at the start of the respective movement path 80b or 80c. This ensures that the series of slice images acquired along the movement paths 80b and 80c can be interlaced and combined for subsequent focus analysis. However, the present disclosure is not limited to the above embodiment. As illustrated in FIG. 10, if the camera device 10a has m unit image capture areas 31 along the movement direction and moves in a V-shaped path (movement paths 80b and 80c), the present disclosure also applies when the camera device 10a moves from the nth unit image capture area 31 to the (n+1)th unit image capture area 31 among the m unit image capture areas 31, after completing one V-shaped path, i.e., after completing one upward path (movement path 80b) and one downward path (movement path 80c). In this case, n and m are natural numbers, and m>n.

Please refer to FIGS. 4A, 5A, 5B, and 6 through 10, and also to FIG. 4B, which is a block diagram of the image processing module of the object profile image capture system of the present disclosure.

As shown in FIGS. 4A and 4B, the object profile image capture system 1 of the present disclosure further comprises an image processing module 60. The image processing module 60 is signal-connected to the control device 50 and is configured to receive a plurality of slice images 800. The image processing module 60 includes an evaluation module 61, an image space transformation module 62, and a matrix transformation module 63. When the camera device 10 moves at a given magnification relative to the object under test 90 along the movement path 80 and acquires the plurality of slice images 800 of the object 90, and there is an image capture interval distance 890 between adjacent slice images 800, the image processing module 60 performs a pixel offset alignment process on the plurality of slice images 800 based on a combination of parameters, including the magnification, the image capture interval distance 890, and the focal plane tilt angle 19, to generate a plurality of images to be evaluated. The evaluation module 61 is configured to perform a Depth From Focus (DFF) Laplacian filter focus evaluation operation to evaluate the focus quality of the plurality of images to be evaluated, thereby generating a 3D depth map 710 in an image coordinate system whose coordinate frame is based on the object-side focal plane normal 151. The image space transformation module 62 is configured to transform the 3D depth map 710, from the object image coordinate system based on the object-side focal plane normal 151, into a world coordinate system 3D depth map 300, which is based on the first plane normal 71.

It should be noted that, because the image sensor imaging module 13 of the lens module 11 in the first embodiment is not parallel to the object-side focal plane 15, the matrix transformation module 63 performs a geometric deformation matrix conversion on each of the plurality of slice images 800 before the image processing module 60 performs the pixel offset alignment process in the first embodiment of the lens module 11. In contrast, for the lens module 11b of the third embodiment, the matrix transformation module 63 performs the geometric deformation matrix conversion on each of the plurality of slice images 800 after the 3D depth map in the image coordinate system has been completed. In a preferred embodiment, each of the aforementioned modules is implemented as a software program, and the functions of the image processing module 60 are executed by a processor (not shown) or by the control device 50 within the object profile image capture system 1.

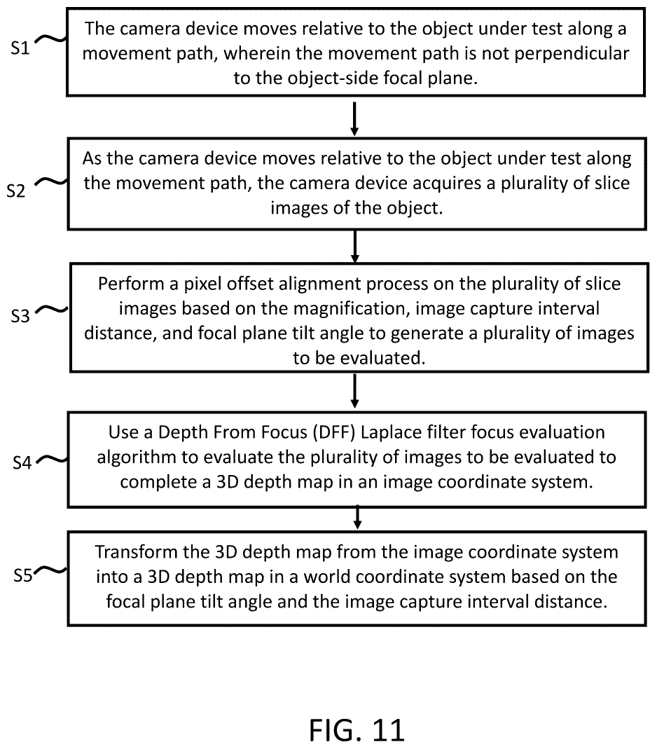

Please refer to FIGS. 4A, 5A, and 8, and also refer to FIG. 11, which is a flowchart of a first embodiment of the object profile image capture method of the present disclosure.

As shown in FIGS. 4A, 5A, and 11, the object profile image capture method of the present disclosure is used in the object profile image capture system 1 of the present disclosure. The steps of the object profile image capture method of the present disclosure are described below. As shown in FIG. 11, the object profile image capture method includes steps S1 through S5.

Step S1: The camera device 10 moves relative to the object under test 90 along a movement path 80, wherein the movement path 80 is not perpendicular to the object-side focal plane 15.

As shown in FIGS. 4A, 5A, and 10, there are two modes for the movement of the camera device 10 relative to the object under test 90 along the movement path 80. In a first mode, the camera device 10 moves to capture images. The camera device 10 continuously moves along two possible embodiments of the first plane 70, which is either the XY plane defined by the first-axis guide rail 21 and the second-axis guide rail 22 (the first plane 70 of FIG. 5), or an oblique plane defined by the movement of the camera device 10 on the transfer platforms of the first-axis guide rail 21 and the third-axis guide rail 23 (the first plane 70a of FIG. 10). Step S2 is performed concurrently, in which the camera device 10 acquires the plurality of slice images 800 of the object under test 90 during its movement along the movement path 80.

In a second mode, the camera device 10 remains stationary, and the object under test 90 moves relative to the camera device 10 along the two possible embodiments of the first plane 70. Step S2 is likewise performed concurrently, in which, as relative movement occurs between the camera device 10 and the object under test 90 along the movement path 80, the camera device 10 acquires the plurality of slice images 800 of the object under test 90. It should be noted that the image capture effect of the two aforementioned movement modes is the same. The second mode, in which the object under test 90 moves while the camera device 10 remains stationary, is suitable for use in laboratory desktop systems employing extremely high transfer precision platforms that require high-resolution object images.

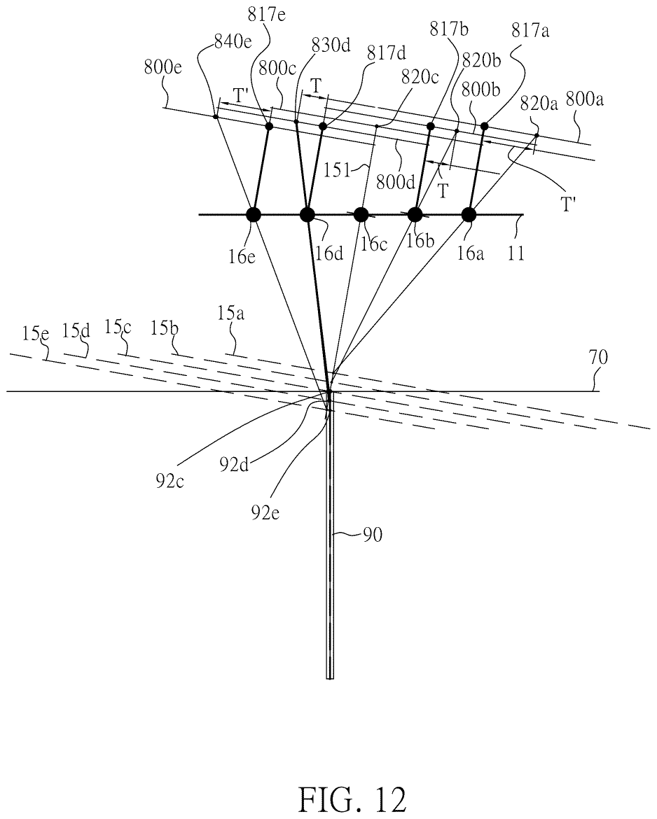

Please refer to FIGS. 12, 13A, 13B, 14A, and 14B to understand the schematic diagrams corresponding to steps S3 through S5 of the present disclosure. These figures illustrate the generation of images to be evaluated after the pixel offset alignment process is completed on the slice images, and the conversion of the 3D depth map 710 from an image coordinate system based on the object-side focal plane normal 151 into a world coordinate system 3D depth map 300 based on the first plane normal 71.

Step S3: Perform a pixel offset alignment process on the plurality of slice images based on the magnification, the image capture interval distance, and the focal plane tilt angle, so as to generate a plurality of images to be evaluated.

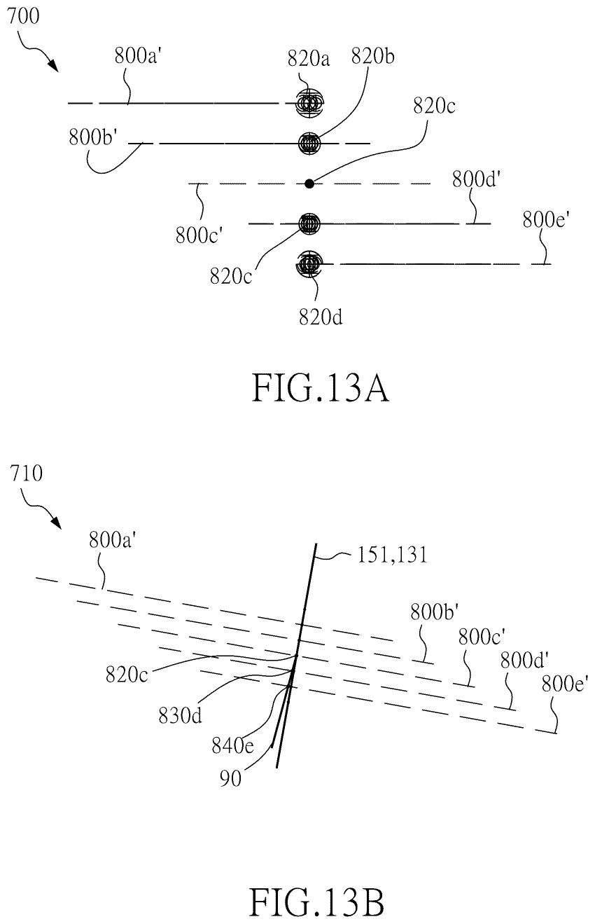

Since the camera device of the present disclosure performs continuous image capture while in motion, the positions of the object points 92c, 92d, and 92e of the object under test 90 continuously change in the different slice images 800, 800a, 800b, 800c, 800d, and 800e. Therefore, a pixel-translation regression correction (also referred to as a pixel-offset alignment process) is required to compensate for and realign the position of the object under test 90 in the slice images 800, 800a, 800b, 800c, 800d, and 800e, so as to generate a plurality of images to be evaluated 700 as shown in FIG. 13A. This facilitates the subsequent depth position evaluation, in which the image transitions from blurry to sharp and then back to blurry, such that the slice index number in sharp focus (i.e., relative height) can be determined to resolve a depth map in the image coordinate system. Specifically, the present disclosure performs the above pixel-translation regression correction based on the adjacent image capture interval distance 890 and the image magnification of the camera device, to correct and align the pixel offset between adjacent layers in the oblique slice images 800a, 800b, 800c, 800d, and 800e.

As shown in FIGS. 5A and 12, the camera device 10b is a conventional camera. As can be seen from FIG. 8, the camera device 10b moves equidistantly to the left along the movement path 80. In this configuration, the focal plane normal 151 of the camera device 10b is parallel to the optical axis 111 of the lens, and the focal plane normal 151 is also parallel to the image sensor imaging plane normal 131. Accordingly, the lens tilt angle 18(θ), defined as the angle between the focal plane normal 151 and the image sensor imaging plane normal 131, is equal to the focal plane tilt angle 19(ω), which is defined as the angle between the focal plane normal 151 and the first plane normal 71. The sensor tilt angle 17(φ), defined as the angle between the optical axis 111 of the lens and the image sensor imaging plane normal 131, is 0 degrees. It is further assumed that θ=ω=10 degrees and that the magnification is 0.5×.

As shown in FIG. 12, the camera device 10a captures slice images 800a, 800b, 800c, 800d, and 800e of a single object under test 90 at the respective object-side focal planes 15a, 15b, 15c, 15d, and 15e. In slice image 800a, the contour feature point images of the object points 92c, 92d, and 92e of the object under test 90 are represented by 820a, 830a, and 840a, respectively. The object points 92c, 92d, and 92e are likewise represented in the same manner in slice images 800b, 800c, and 800d, as illustrated in FIG. 12. For ease of illustration, the concrete moving positions of the camera device 10a are indicated by the lens center points 16a, 16b, 16c, 16d, and 16e on the lens module 11, and the lens center points 16a, 16b, 16c, 16d, and 16e correspond to the respective image reference points 817a, 817b, 817c, 817d, and 817e in the slice images 800a, 800b, 800c, 800d, and 800e. As shown in FIG. 12, in slice image 800a, a pixel offset T exists between the contour feature point image 820b of object point 92c and the image reference point 817b corresponding to the lens center point 16b. In slice image 800a, a pixel offset T′ exists between the contour feature point image 820a of object point 92c and the image reference point 819a corresponding to the lens center point 17a, where T=2T′. The reason for the different pixel offsets T and T′ among slice images 800a, 800b, 800c, and 800d is that the present disclosure adopts slice image 800c as the center, and its image reference point 817c is used as the central reference point. Therefore, the farther a slice image is from slice image 800c, the larger the pixel offset T becomes. Assuming that the total number of slice images is p+1 and that the

$$\frac{p}{2} th$$

slice is the center slice, and further assuming that the image capture interval distance 890 between two adjacent slice images is q, the pixel offset T of the

$$\frac{p}{2} + 1 th$$

slice and the

$$\frac{p}{2} - 1 th$$

slice is q, and the pixel offset T of the slice is q, and the pixel offset T of the slice and the first slice and the (p+1)th slice is

$$q \times \frac{p}{2} .$$

By accordingly applying the pixel offset alignment process to the slice images 800a, 800b, 800c, and 800d shown in FIG. 12, a plurality of images to be evaluated 700 are generated, as illustrated in FIG. 13A. As shown in FIG. 13A, the object point 92c in the aligned slice image 800c′ is in sharp focus.

Step S4: A Depth From Focus (DFF) Laplacian filter focus evaluation algorithm is used to evaluate the plurality of images to be evaluated, so as to complete a 3D depth map in an image coordinate system.

Specifically, in Step S4, the present disclosure adopts the Laplacian filter-based focus evaluation algorithm of the conventional depth-from-focus (DFF) technique. From the series of images to be evaluated 700, the algorithm determines, for each pixel of the slice images of the object under test 90, the slice image index number having the best focus (i.e., the maximum convolution value). For example, in the case of the object point 92c, the contour feature point image 820c is determined to correspond to slice image 800c as the focal position of the object point 92c, thereby completing the object image coordinate system 3D depth map 710 (as shown in FIG. 13B) in the image coordinate system 200, using the object-side focal plane normal 151 as the coordinate reference. Assuming, as shown in FIG. 13A, that the object point 92c has a sharp contour feature point image 820c in the aligned slice image 800c′, the Laplacian filter records the index number (relative height) of the aligned slice image 800c′ corresponding to that sharp contour feature point image 820c. It should be noted that, at this stage, the 3D depth map 710 already represents the profile contour 91 of the object under test 90. Since the technical details of the Laplacian filter-based focus evaluation algorithm of the DFF technique are well known to those skilled in the art, a further detailed operational description thereof is omitted herein for brevity.

Step S5: Transform the 3D depth map in the image coordinate system into a 3D depth map in the world coordinate system based on the focal plane tilt angle and the image capture interval distance.

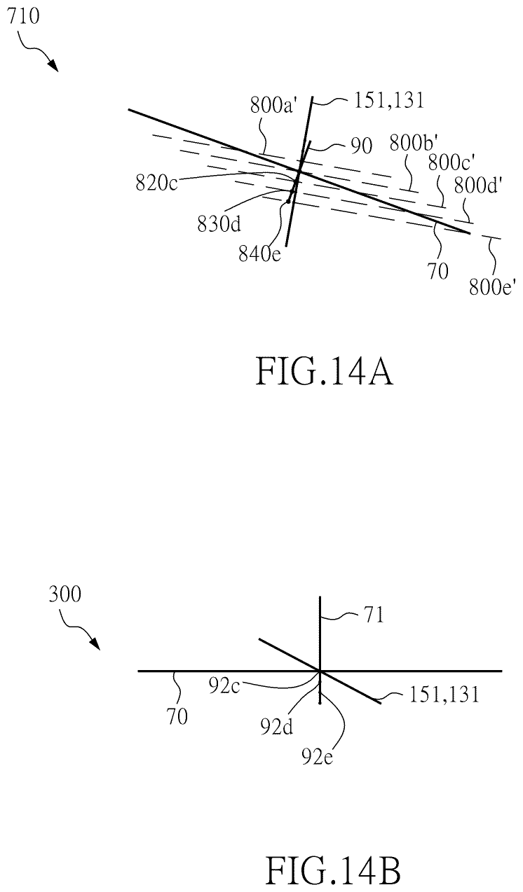

Furthermore, the 3D depth map generated in Step S4 is the 3D depth map 710 in the image coordinate system, in which the coordinate frame is based on the object-side focal plane normal 151. Accordingly, an image space transformation (Step S5) is performed using a spatial rotation matrix,

$${R}_{y} ( {ω}_{y} ) = [ \begin{matrix}cos {ω}_{y} & 0 & sin {ω}_{y} \\ 0 & 1 & 0 \\ - sin {ω}_{y} & 0 & cos {ω}_{y}\end{matrix} ]$$

where ω_{y} is the focal plane tilt angle 19(ω). This rotation matrix transforms the 3D depth map 710 from the image coordinate system based on the object-side focal plane normal 151 into the world coordinate system 3D depth map 300 (the real world), which is based on the first plane normal 71. As illustrated in FIGS. 14A and 14B, the true 3D depth dimensions (3D point cloud) of the object under test 90 relative to the first plane 70 (the XY plane) are thereby obtained.

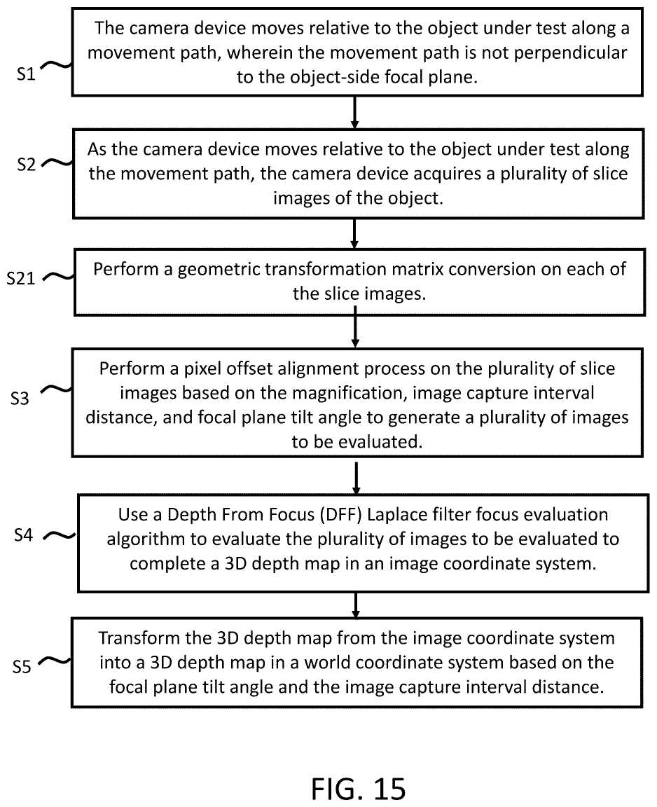

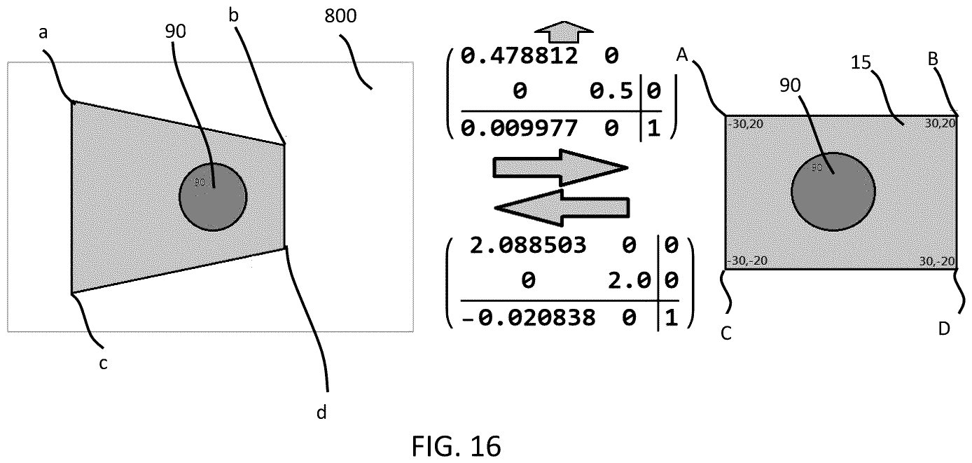

Please continue to refer to FIGS. 4A, 5A, 6, 7, and 9, and also refer to FIGS. 15 and 16 to understand the flowchart of the second embodiment of the object profile image capture method of the present disclosure, as well as the image processing method for performing trapezoidal distortion correction and projection coordinate transformation corresponding to the focal plane on the image sensor.

Because the object-side focal plane 15 and the image sensor imaging plane 13 in the lens modules 11 and 11b (the first and third embodiments) of the present disclosure are not parallel and form an angle, the imaging of the object's focal plane in the plurality of slice images 800a, 800b, 800c, 800d, and 800e acquired by the camera device 10 exhibits perspective distortion. Therefore, the slice images 800a, 800b, 800c, 800d, and 800e must undergo an image processing operation in the form of a spatial projection geometric transformation so as to correctly present the image position of the object under test 90 in the world coordinate system 300, which is defined with reference to the first plane normal 71.

As shown in FIG. 7, the basic principle of thin-lens optical imaging is that an image of a point on an object under test is formed where the central ray and a parallel ray intersect at the focal point after passing through the lens. If an image sensor is placed at this intersection, a sharply focused image point can be obtained, while other objects in front of or behind this object will become progressively blurry. If it is desired to have two specific, non-overlapping points (or three points, or a plane) in the field of view be simultaneously in focus, this can be achieved by adjusting the tilt angle of the image sensor so that these two points (or three points, or a plane) are simultaneously sharp. This is the Scheimpflug Intersection Principle for optical path imaging. The Scheimpflug principle states that when a planar object is not parallel to the image plane, oblique lines can be extended from the image plane, the object plane, and the lens plane, and their point of intersection is called the Scheimpflug intersection point. The technology of the present disclosure applies this principle to determine the locked-in relationship between the lens tilt angle 18(φ), the sensor tilt angle 17(θ), and the focal plane tilt angle 19(ω).

Because a feature of the present disclosure is that the camera device 10 moves to acquire slice images of the object under test 90 on a tilted focal plane (i.e., oblique slice images 800), the image of the object under test 90 appears at different positions along the path on the image sensor imaging plane of the image sensor imaging module 13. Therefore, for the lens modules 11 and 11b (the first and third embodiments) of the present disclosure, as shown in FIG. 15, it is necessary to perform a spatial geometric matrix image coordinate transformation corresponding to the focal plane on the image sensor (Step S21: perform a geometric transformation matrix conversion on each slice image 800) before executing the pixel offset alignment process along the moving direction (Step S3).

As shown in FIG. 16, according to the aforementioned Scheimpflug principle, for the lens modules 11 and 11b (the first and third embodiments) of the present disclosure, both lens modules 11 and 11b are tilted, and their respective focal plane tilt angles 19(ω) are not equal to zero. As illustrated in FIG. 16, in the first and third embodiments of the present disclosure, the geometric relationship between the image sensor imaging plane 13 and the object-side focal plane 15 is such that a rectangular image sensor plane corresponds to a trapezoidal focal plane. When an object in the world coordinate system, which is based on the first plane normal 71, is projected into the image coordinate system based on the object-side focal plane normal 151, geometric distortion occurs. Therefore, the plurality of slice images 800 must undergo a geometric transformation matrix conversion to convert each trapezoidal slice image acquired by the lens modules 11 and 11b back into a rectangle in the world coordinate system. The geometric correspondence between the pixel coordinates a(−20.5, 14.27), b(11.055, 7.70), c(−20.5, −14.27), and d(11.055, −7.70) in the slice image 800 and the feature point coordinates A(−30, 20), B(30, 20), C(−30, −20), and D(30, −20) on the object-side focal plane 15 is accomplished by the transformation matrix shown in FIG. 16, where the matrix parameters are determined based on the Scheimpflug principle illustrated in FIG. 7.

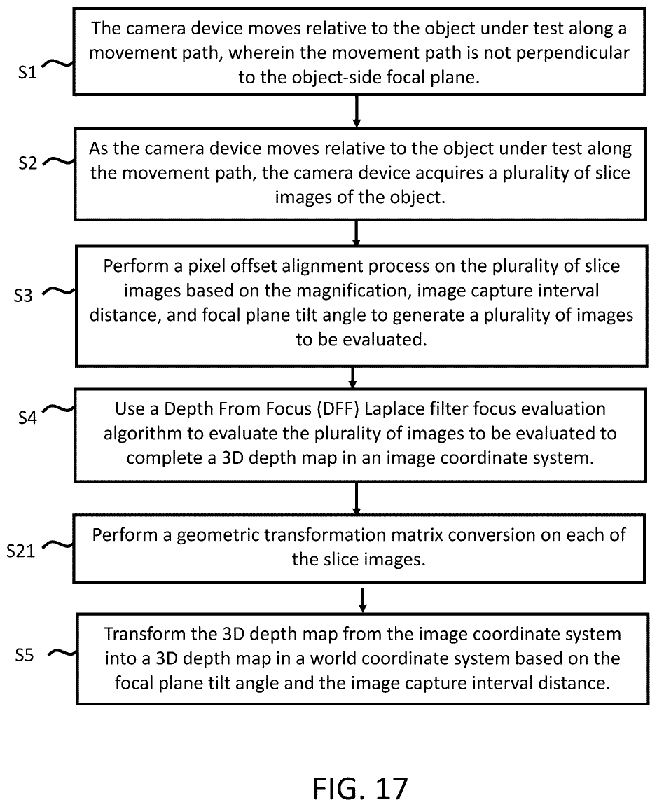

Please continue to refer to FIGS. 4A, 5A, 6, 7, and 9, and also refer to FIGS. 17 through 22 to understand the flowchart of the third embodiment of the object profile image capture method of the present disclosure, as well as the image processing method for trapezoidal distortion correction and projection coordinate transformation corresponding to the focal plane on the image sensor.

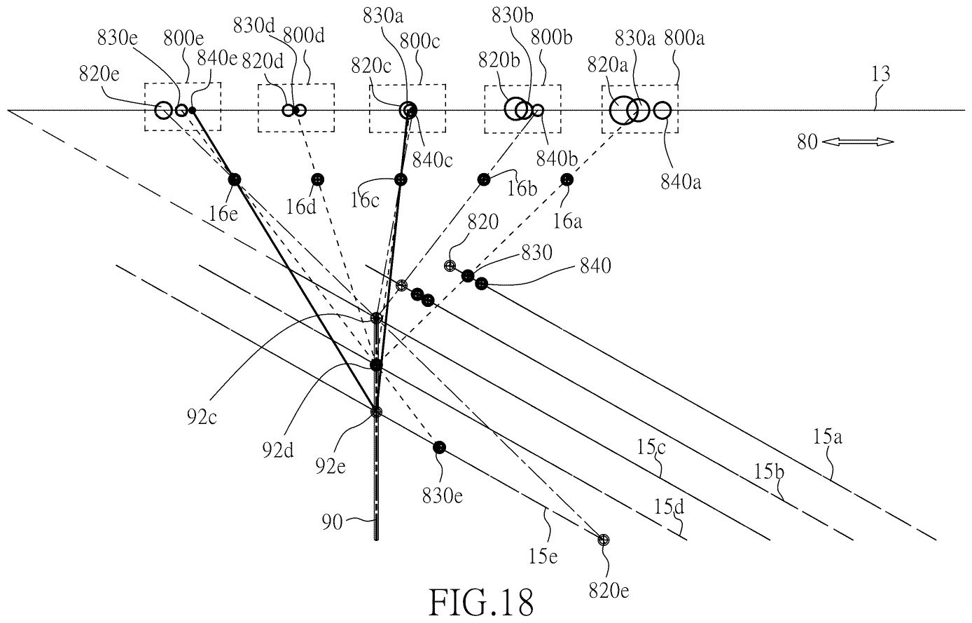

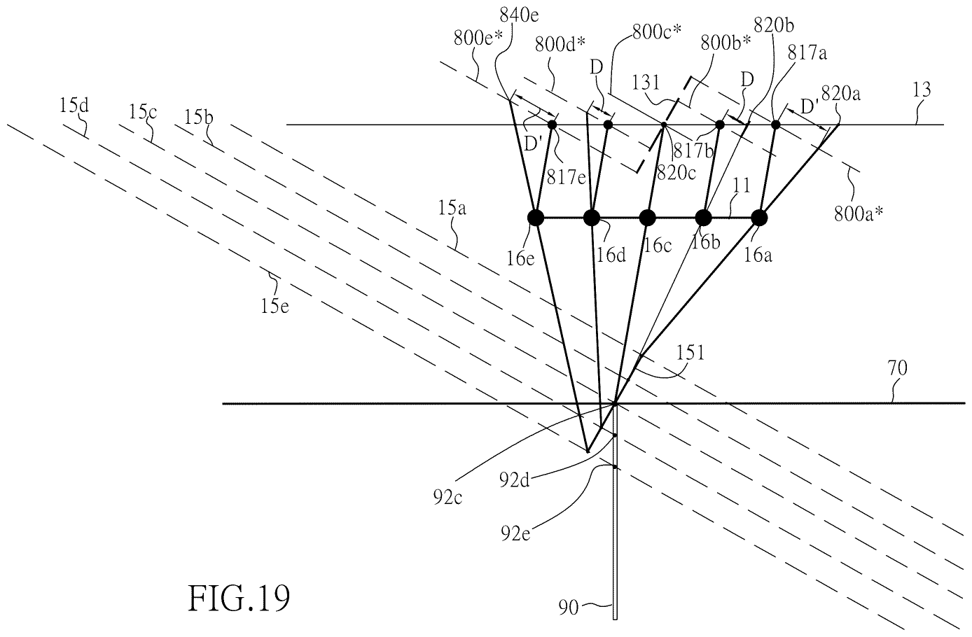

As shown in FIG. 18, for ease of illustration, the slice images 800, 800a, 800b, 800c, and 800d are schematically displayed on the image sensor imaging plane 13 shown in FIG. 12. As illustrated in FIG. 18, because the focal length and focal point of the camera device 10b are fixed, the contour feature point images corresponding to the object points 92c, 92d, and 92e—namely image 820 (the image of object point 92c in slice image 800a), image 830 (the image of object point 92d in slice image 800a), and image 840 (the image of object point 92e in slice image 800a) —become progressively sharper as the object points 92c, 92d, and 92e enter the field of view of the camera and move toward the focal point, and then progressively blur again as they move away from the focal point and exit the field of view. In other words, the contour feature point images 820, 830, and 840 in slice images 800, 800a, 800b, 800c, and 800d exhibit a transition from blurry to sharp and then back to blurry, which facilitates subsequent depth position evaluation. It should be noted that the slice images 800, 800a, 800b, 800c, and 800d in FIG. 18 are the original captured images. Because the object-side focal plane 15 is tilted, the actual projected slice images after trapezoidal/rectangular distortion correction, namely 800*, 800a*, 800b*, 800c*, and 800d*, are shown in FIG. 19. The present disclosure uses the lens module of the third embodiment as an example to illustrate the phenomenon in which the image of an object point on the focal plane transitions from blurry to sharp and back to blurry on the image sensor. The first and second embodiments of the lens module will exhibit the same phenomenon during moving image capture and therefore will not be repeatedly described.

As shown in FIGS. 9 and 5A, if the image sensor imaging module 13 of the third embodiment of the lens module 11b is configured to be parallel to the movement path 80 on the first plane 70 (such that the point under test maintains a fixed depth distance from the image sensor imaging module 13), then, because the sensor tilt angle 17(φ) is equal to the lens tilt angle 18(θ), no relative magnification change occurs in the image of the object under test during its transition from in-focus to out-of-focus while capturing images in motion. Therefore, the trapezoidal distortion correction for each slice image, which would normally be performed prior to the pixel offset alignment process, may instead be postponed until after Step S4, thereby saving computational power. In this case, the third embodiment of the lens module 11b operates similarly to the second embodiment of the lens module 11a (for which a telecentric lens is preferable, as described in paragraph [0007]), requiring only equidistant translation correction between slices, followed by focused slice search to establish the 3D object profile. However, if the sensor tilt angle 17(φ) is not equal to the lens tilt angle 18(θ), then the third embodiment of the lens module 11b operates in the same manner as the first embodiment of the lens module 11, and each slice image must first undergo a geometric transformation matrix conversion for trapezoidal distortion (i.e., Step S21 must be executed). As shown in FIG. 17, however, the order of executing Step S21 differs from that of the first embodiment, as Step S21 in the third embodiment of the lens module 11b is performed after Step S4 has been completed.

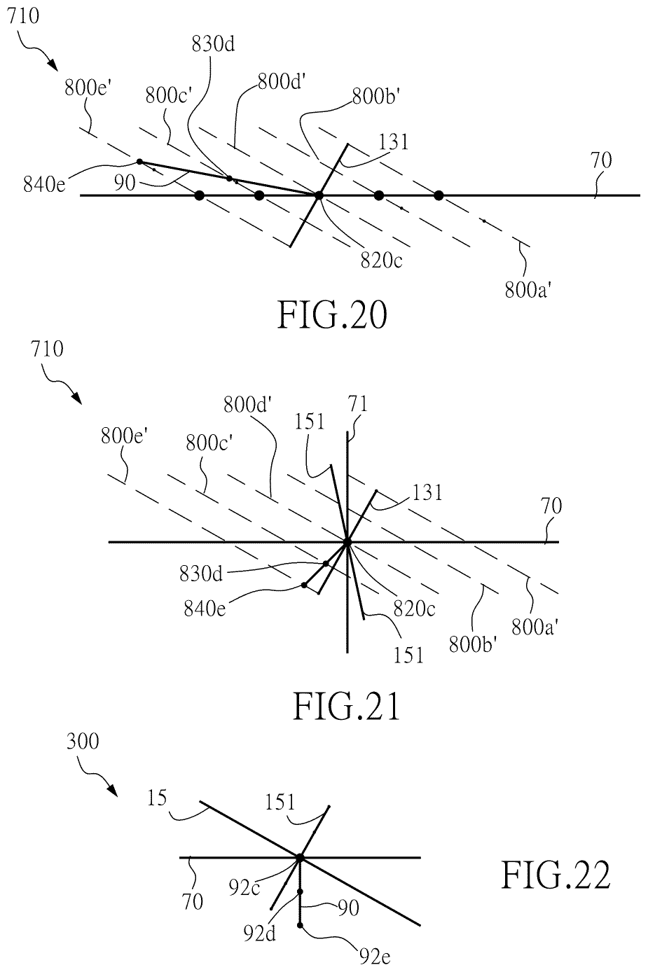

As shown in FIGS. 19 to 22, the camera device 10 performs a series of continuous image captures (acquiring a plurality of slice images 800) using the third embodiment of the lens module 11b. As shown in FIGS. 19 and 20, the pixel displacement (offset) between adjacent slice image regions is corrected based on the magnification of the camera device 10 and the plurality of image capture interval distances, followed by a pixel offset alignment process to generate a plurality of images to be evaluated 700 (refer to FIG. 13A; the related content is not repeated here). A Depth From Focus (DFF) Laplacian filter focus evaluation algorithm is then executed to generate the object image coordinate system 3D depth map 710 (FIG. 21) in the image coordinate system 200. Finally, as shown in FIG. 22, an image space transformation (Step S5) is performed to transform the 3D depth map 710 from the image coordinate system into the world coordinate system 3D depth map 300 (the real world), thereby obtaining the correct 3D depth dimensions (3D data point cloud) of the object under test 90 relative to the first plane 70 (the XY plane).

The object profile image capture systems 1 and 1a of the present disclosure utilize the feature that the movement path 80 of the camera device 10 is not perpendicular to the object-side focal plane 15. This enables the camera device of the present disclosure to perform high-speed continuous image capture solely by moving laterally (e.g., along the X-axis or on the XZ plane), while still achieving accurate 3D contour reconstruction. This effectively solves the problem in the prior art wherein, when the object under test is larger than the camera's field of view, the conventional camera device 100a becomes idle and does not capture images during the process of the XY transfer platform moving or the object moving to a new field of view, resulting in low image capture operational efficiency and low detection capability.

It should be noted that many of the above-mentioned embodiments are given as examples for description, and the scope of the present disclosure should be limited to the scope of the following claims and not limited by the above embodiments.

What is claimed is:

1. An object profile image capture system for analyzing a profile contour of an object by evaluating changes in focus quality of a plurality of slice images, the system comprising:
a camera device comprising a lens module and an image sensor imaging module, wherein the lens module and the image sensor imaging module form an object-side focal plane;
a moving device configured to move the camera device relative to the object along a movement path, wherein the movement path is not perpendicular to the object-side focal plane; and
a control device electrically connected to the camera device and the moving device, the control device being configured to control the moving device to move, and to control the camera device to acquire the plurality of slice images as the camera device moves relative to the object along the movement path.

2. The system as claimed in claim 1, wherein the moving device comprises a first-axis guide rail, a second-axis guide rail, and a third-axis guide rail, wherein any two of the first-axis guide rail, the second-axis guide rail, and the third-axis guide rail define a first plane, the camera device being configured to move on the first plane along the movement path relative to the object, and wherein a first plane normal of the first plane and a normal of the object-side focal plane form a focal plane tilt angle ranging from 0.1 degrees to 60 degrees.

3. The system as claimed in claim 2, wherein an optical axis of the lens module is perpendicular to the movement path, and wherein a normal of the image sensor imaging plane of the image sensor imaging module and the optical axis form a sensor tilt angle ranging from 0.1 degrees to 60 degrees.

4. The system as claimed in claim 2, wherein an optical axis of the lens module is not perpendicular to the movement path, and wherein the optical axis of the lens module and the movement path form a lens tilt angle ranging from 0.1 degrees to 60 degrees.

5. The system as claimed in claim 4, wherein a normal of the image sensor imaging plane of the image sensor imaging module is parallel to the optical axis of the lens module.

6. The system as claimed in claim 4, wherein a normal of the image sensor imaging plane of the image sensor imaging module is not parallel to the optical axis of the lens module, and wherein the normal of the image sensor imaging plane and the optical axis form a sensor tilt angle ranging from 0.1 degrees to 60 degrees.

7. The system as claimed in claim 1, wherein an image capture frequency of the camera device ranges from 1 frame per second to 1000 frames per second.

8. The system as claimed in claim 2, wherein the camera device has m unit image capture ranges along a movement direction, and wherein the movement path is a V-shaped path, such that when the camera device completes the V-shaped path, the camera device moves from an nth one of the m unit image capture ranges to an (n+1)th one of the m unit image capture ranges, n and m being natural numbers, and m>n.

9. The system as claimed in claim 8, wherein a slice interval thickness is provided between two adjacent slice images, and wherein the V-shaped path comprises a descending path and an ascending path, such that a depth difference between an end point of the descending path and a start point of the ascending path is 0.5 times the slice interval thickness.

10. The system as claimed in claim 2, further comprising an image processing module signal-connected to the control device, wherein the camera device moves relative to the object along the movement path with a magnification to acquire the plurality of slice images of the object, each pair of adjacent slice images having an image capture interval distance, and wherein the image processing module is configured to perform a pixel-translation alignment process on the plurality of slice images based on the magnification, the image capture interval distance, and the focal plane tilt angle, so as to generate a plurality of images to be evaluated.

11. The system as claimed in claim 10, wherein the image processing module comprises an evaluation module configured to evaluate the plurality of images to be evaluated by using a Laplacian filter-based Depth From Focus (DFF) focus evaluation algorithm, so as to generate an image coordinate system 3D depth map.

12. The system as claimed in claim 10, wherein the image processing module comprises an image space transformation module configured to transform the image coordinate system 3D depth map into a world coordinate system 3D depth map based on the focal plane tilt angle and the image capture interval distance.

13. The system as claimed in claim 10, wherein the image processing module comprises a matrix transformation module configured to perform a geometric transformation matrix conversion on each of the plurality of slice images before the pixel-translation alignment process is performed, when an image sensor imaging module is not parallel to the object-side focal plane.

14. The system as claimed in claim 10, wherein the image processing module comprises a matrix transformation module configured to perform a geometric transformation matrix conversion on each of the plurality of slice images after the image coordinate system 3D depth map is generated, when an image sensor imaging module is not parallel to the object-side focal plane.

15. An object profile image capture method for acquiring a plurality of slice images of an object by moving a camera device relative to the object using a moving device, and for determining a profile contour of the object by evaluating changes in focus quality of the plurality of slice images, the camera device comprising a lens module and an image sensor imaging module, the lens module and the image sensor imaging module forming an object-side focal plane, the method comprising:
moving the camera device relative to the object along a movement path, wherein the movement path is not perpendicular to the object-side focal plane; and
acquiring, by the camera device, the plurality of slice images of the object as the camera device moves relative to the object along the movement path.

16. The method as claimed in claim 15, wherein the camera device moves relative to the object along the movement path on a first plane, a first plane normal of the first plane and a normal of the object-side focal plane forming a focal plane tilt angle, the camera device moving relative to the object along the movement path with a magnification to acquire the plurality of slice images of the object, each pair of adjacent slice images having an image capture interval distance, the method comprising:
performing a pixel-translation alignment process on the plurality of slice images based on the magnification, the image capture interval distance, and the focal plane tilt angle to generate a plurality of images to be evaluated; and
evaluating the plurality of images to be evaluated by using a Laplacian filter-based Depth From Focus (DFF) focus evaluation algorithm to generate an image coordinate system 3D depth map.

17. The method as claimed in claim 16, wherein the focal plane tilt angle ranges from 0.1 degrees to 60 degrees.

18. The method as claimed in claim 16, further comprising transforming the image coordinate system 3D depth map into a world coordinate system 3D depth map based on the focal plane tilt angle and the image capture interval distance, the world coordinate system being referenced to a first plane normal.

19. The method as claimed in claim 16, wherein, when the image sensor imaging module is not parallel to the object-side focal plane, the method further comprises, before performing the pixel-translation alignment process on the plurality of slice images:
performing a geometric transformation matrix conversion on each of the plurality of slice images.

20. The method as claimed in claim 16, wherein, when the image sensor imaging module is not parallel to the object-side focal plane, the method further comprises, after the image coordinate system 3D depth map is generated:
performing a geometric transformation matrix conversion on each of the plurality of slice images.
